(19) United States
(12) Patent Application Publication
(10) Pub. No.: US 2013/0246414 A1
(43) Pub. Date: Sep. 19, 2013

(54) SEARCH RESULTS PERSONALIZATION BASED ON EXPLICITLY PREFERRED SOURCES

(71) Applicants: Rahul Nair, Daly City, CA (US); Simon P. King, Berkeley, CA (US); Imran Aziz, Seattle, WA (US); Marc Eliot Davis, San Francisco, CA (US)

(72) Inventors: Rahul Nair, Daly City, CA (US); Simon P. King, Berkeley, CA (US); Imran Aziz, Seattle, WA (US); Marc Eliot Davis, San Francisco, CA (US)

(73) Assignee: MICROSOFT CORPORATION, Redmond, WA (US)

(21) Appl. No.: 13/419,371

(22) Filed: Mar. 13, 2012

(51) Int. Cl. G06F 17/30

(52) U.S. Cl. 707/732; 707/E17.014

(57) ABSTRACT

While some search engines personalize search results for a user, search engines have failed to enable personalization according to a user's explicitly preferred sources of content. According to the disclosed subject matter, a list of preferred sources is maintained for a user. When a search query is received from the user, a set of search results responsive to the query is obtained. From the set search results, one or more search results that correspond to a preferred source are identified. The set of search results is arranged with the one or more search results placed in more prominent positions in the set of search of search results. A search results page is generated according to the arranged set of search results and the generated search results page is returned in response to the user's search query.

### BACKGROUND

Just as individual tastes vary in regards to food, activities, brands, clothing, and the like, different individual tastes also vary with regard to online sources of information. Accordingly, some leading search engines have begun customizing the search results they generate in response to a query received from a particular user according to the user's specific preferences. However, while some of these preferences can be detected implicitly via click through data browsing habits, prior search queries, and even a user's social network, there are advantages to allowing a user to state his/her preferences explicitly.

Often, a user will have a specific preference with regard to the source of content that he/she would like to see. In other words, a user may have a specific preference for content that originates from, or is sponsored by, a “preferred source.” For example, a user may have a preference of viewing search results for news from a specific source such as MSNBC or CNET. Thus, when search results are obtained in response to a search query, ideally those search results that reference content from a preferred source would be promoted to, or placed in, more prominent positions in the search results.

Some search engines have experimented with permitting users to rearrange the search results of a search page. However, even when the user manually rearranges the search results, the search engine must make inferences as to what the rearranged order means. Never does the user simply state, “I prefer to receive search results from this source.” Moreover, one of the limitations of these experiments is that the user is limited to rearranging a very small subset of the entire set of results that a search engine might find in response to a specific query. In particular, the user is limited to rearranging the order of the search results that are displayed in a single search results page, i.e., limited to the search results shown in a browser window at a given time. In other words, the user is limited to rearranging the order of the “10 blue links.” Unfortunately, this creates significant difficulty for the user in promoting a search result to a prominent position on the first page of search results when the result resides on another page.

### SUMMARY

While many search engines attempt to implicitly identify a user's preferences and intent, and even leverage preferences that a user may explicitly make to specific content, search engines have thus far failed to enable a user to explicitly identify preferred sources of content and, in turn, utilize these preferred sources in responding to search queries. Thus, according to one embodiment of the disclosed subject matter, a computer-implemented method for personalizing search results responsive to a search query is presented. In this method, a search query is received from the user. Upon receiving the search query, a set of search results responsive to the search query is obtained. From this set of search results, one or more search results from the set of search results that correspond to a preferred source of the user are identified. The set of search results is rearranged with the one or more search results placed in more prominent positions in the set of search of search results. A search results page is generated according to the rearranged set of search results and the generated search results page is returned in response to the user's search query.

In an alternative embodiment of the disclosed subject matter, a computer-implemented system for personalizing search results according to a user's preferred sources is presented. This system includes a processor and a memory. Those skilled in the art will appreciate that the processor executes instructions stored in the memory as part of or in conjunction with additional components of the system to customize search results according to the user's preferred sources. These additional components (being actual and/or logical components) include a network communication component, a search results retrieval component, a search results personalization component, a search results page generator component, and preferred source store. The preferred source store maintains a list of preferred sources for each of a plurality of users. In operation, the system receives information regarding a search query from a user via the network communication component. Based on the search query, the system obtains a set of search results responsive to the search query via the search results retrieval component. With this initial set of search results, the system identifies a at least one search result from the set of search results that corresponds to a preferred source from the list of preferred sources maintained for the user within the preferred source store. The system rearranges the set of search results with the at least one search result placed in a more prominent position in the set search of search results via the search results personalization component. Thereafter, the system generates a search results page according to the rearranged set of search results via the search results page generation component. In generating the search results page, the system identifies the at least one search result with an indicator signifying that the at least one search result is from a preferred source. The system then returns the generated search results page in response to the search query via the network communication component.

In yet another embodiment of the disclosed subject matter, a computer-readable medium bearing computer-executable instructions is presented. When the instructions are executed on a computing system (comprising least a processor and a memory), they carry out the following steps, including first receiving a search query from a user. Responsive to the search query, an initial set of search results is obtained. The initial set of search results comprises a set of search results ordered according to a score for each search result in the set. At least one search result that corresponds to a preferred source of the user is identified from a subset of the initial set of search results. The subset comprises a number of search results greater than the number of search results that can be included in a generated search results page. The initial set of search results is then rearranged with the at least one first search result placed in a more prominent position in the rearranged set search of search results, such that the at least one search result will be included in the first generated search results page for the rearranged set of search results. From the rearranged set of search results, a first search results page is generated. This first search results page is generated to include a preferred source indicator proximate to the at least one search result indicating that the at least one search result is from a preferred source. Thereafter, the first search results page is returned to the user in response to the search query.

While various novel aspects of the disclosure subject matter have been set forth in this summary, it should be appreciated that they are for illustration purposes and should not be construed as a complete summary of the novel aspects of the disclosed subject matter that are set forth this document.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram of an illustrative environment in which user personalization according to preferred sources can be implemented;

FIG. 2 illustrates an exemplary browser window showing search results responsive to a search query but have not been personalized according to explicit user personalization;

FIG. 3 illustrates an exemplary browser window showing search results responsive to a search query that are updated according to explicit user personalization;

FIG. 4A illustrates an exemplary user interaction with regard to a search result identified as being from a preferred source;

FIG. 4B illustrates an exemplary user interaction with regard to a search result that is not from a preferred source;

FIG. 5 illustrates an exemplary browser window 500 for displaying and editing a user's preferred sources;

FIG. 6 illustrates a flow diagram, as executed by a search engine, for receiving an indication from a user that the source of a search result is to be preferred for that user;

FIG. 7 illustrates a flow diagram, as executed by a search engine, for receiving explicitly identified preferred sources;

FIG. 8 illustrates a flow diagram for presenting and processing recommended preferred sources to a user;

FIG. 9 illustrates a flow diagram for processing a set of search results responsive to a user's query in accordance with the user's preferred sources;

FIG. 10 illustrates various components of a computing system suitable for personalizing search results according to a user's preferred sources; and

FIG. 11 illustrates an alternative flow diagram for processing a set of search results responsive to a user's query in accordance with the user's preferred sources.

### DETAILED DESCRIPTION

For purposed of clarity, the use of the term “exemplary” in this document should be interpreted as serving as an illustration or example of something, and it should not be interpreted as an ideal and/or leading illustration of that thing.

As used throughout this document, a “source” is an entity that creates, generates, and/or promotes content that can be acted on (often viewed) by a user. Examples of sources include, but are not limited to, a news organization (such as MSNBC or the Huffington Post), an author, a blogger, an organization or association, and the like. A source is distinct from content in that content is originated and/or promoted by the source. In other words, content “flows” from its source. In the context of a search engine responding to a search query, the links/references returned as search results to the search query are links to content, whereas the originator of the referenced content is the source of the content. In this regard, a link to an article published by MSNBC on “Syrian protests” is a link to content (the article on Syrian protests) from a source (MSNBC). Content originated by a source may be published through various conduits and channels. For example, a popular, well-published author such as Dave Barry (a source) may publish content through different channels such as a Dave Barry web site, a news service (e.g., the Miami Herald), books, and the like. A “preferred source,” then, is a source that is preferred by a user and an “explicitly preferred source” is a source that has been explicitly identified by a user as a preferred source for that user. For purposes of this document, when referring to a “preferred source” without other modifiers, it is to be assumed that it is a reference to an explicitly preferred source.

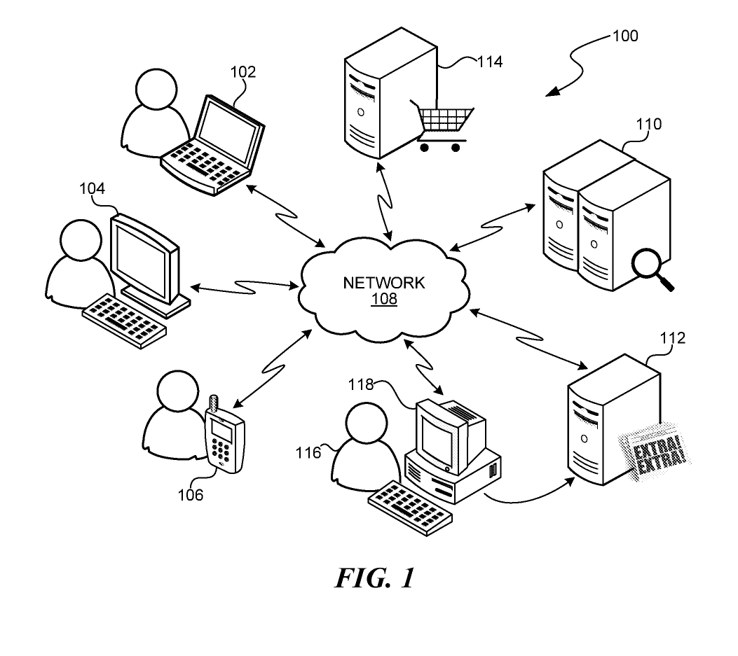

Turning now to the figures, FIG. 1 shows a diagram of an illustrative environment 100 in which user personalization according to preferred sources can be implemented. The illustrative environment 100 includes one or more user computers, such as user computers 102-106, connected to a network 108, such as the Internet, a wide area network or WAN, and the like. Also connected to the network 108 is a search engine 110 that responds to search queries received from various users, such as the users connected to user computers 102-106. Further connected to the network 108 are one or more sources of various types, such as news organization 112, shopping site 114, and an author 116 directly connected to the network via the author's own computer system 118 as well as indirectly connected to the network via news organization 112.

As those skilled in the art will appreciate, suitable user computers for operating in the illustrative environment 100 include any number of computing devices that can communicate with the search engine 110 over the network 108 in both submitting user queries and receiving a response of search results page from the search engine 110. The user computers 102-106 are also configured to enable a corresponding user to identify a source as a preferred source. User computers 102-106 may communicate with the network 108 via wired or wireless communication connections. These user computers 102-106 may include, but are not limited to, laptop computers such as user computer 102, desktop computers such as user computer 104, mobile phone devices such as user computer 106, tablet computers (not shown), on-board computing systems (not shown)such as those found in vehicles, mini- and/or main-frame computers (not shown), and the like.

Those skilled in the art will appreciate that a search engine 110 corresponds to an online service hosted on one or more computers on or computing systems distributed throughout the network 108. The illustrated search engine 110 is shown as comprising two computing devices but this is illustrative only. The online search service hosted by search engine 110 receives search queries over the network 108 and, in response to the queries, identifies a set of search results (typically references to content) that the search engines identifies as being relevant to a received search query. In addition to identifying the search results that are relevant to the search query, according to novel aspects of the disclosed subject matter the search engine 110 personalizes the search results according to the preferred sources of the user submitting the search query. This personalization is accomplished at least by determining whether any of the search results responsive to a search query correspond to a preferred source of the user that submitted the search query. For those results that are identified as corresponding to a preferred source, those identified search results are repositioned in the search results page to more prominent positions in the search results list. The search engine further generates a search results page for presentation to the user based on the rearranged search results list, and returns the search results page to the requesting user.

Those skilled in the art will appreciate that the search results that the search engine obtains in response to a search query are ordered in the sense that those search results deemed more relevant and/or likely to be desired by the user are located in the first portion of the search results list. Often, the search results in the search results list will be associated with a relevance score. Rearranging search results to a more prominent position means taking search results from their current position within the search results list and placing them closer to the start of the list. An earlier position in the search results list is “more prominent” as the earlier results in the search results list are those that are most likely viewed by a user. According to various embodiments, rearranging/repositioning the search results to more prominent positions can be accomplished irrespective of the scores associated with the search results or, alternatively, the scores of the search results that are from preferred sources can be rescored with additional weighting in light of their origin from a preferred source. In addition to earlier in the search results list, prominence may also be made with regard to the search results page in which the results will be included, as well as the position of the “preferred results” on a search results page with respect to the other results on the same search page.

Returning to FIG. 1, the illustrative environment 100 includes a shopping site 114 connected to the network 108. In this environment 100, the shopping site 114 provides information (i.e., content) to, or is crawled by, the search engine 110 regarding products that are available for purchase on the shopping site. This information is then used by the search engine 110 when responding to relevant search queries for those products or services. Hence, assuming that shopping site 114 is a preferred source for a particular user, when responding to search queries from that user content from the shopping site will be promoted to more prominent positions in the search results pages that are returned from the search engine 110.

The illustrative environment 100 also includes a news organization 112. As mentioned above, the news organization 112 may be viewed as a preferred source such that the news articles that are published by the news organization are content. Just as with the shopping site 114, the search engine 110 will be informed of, or will crawl, the articles. Accordingly, when responding to search queries, content from preferred sources (such as news organization 112—assuming it is a preferred source) will be promoted to more prominent positions in the search results that are returned from the search engine 110 to the user in response to the search query.

The illustrative environment 100 further includes an author 116 (i.e., a source of content) connected to the network 108 via the author's own computer system 118 as well as via the news organization 112. This is illustrative of the fact that content from the author 116 may be distributed through any number of channels, i.e., the author's own system 118 as well as the news organization 112. This further shows that the news organization 112 can server both as a conduit for content (i.e., articles by the author 116) and as well as a source itself. The content from the author will then be indexed by the search engine 110, as is known to those skilled in the art, such that the content can be served to users in response to relevant search queries.

While FIG. 1 is described in regard to a variety of devices, components and sources, those skilled in the art will appreciate that in an actual embodiment, there are likely numerous shopping sites, news organizations, authors, and other “sources” connected to the network 108 and the search engine 110. The search engine 110 is informed of, or crawls, numerous sites in an effort to identify and index the available content and their source such that the content can be served to users in response to search queries.

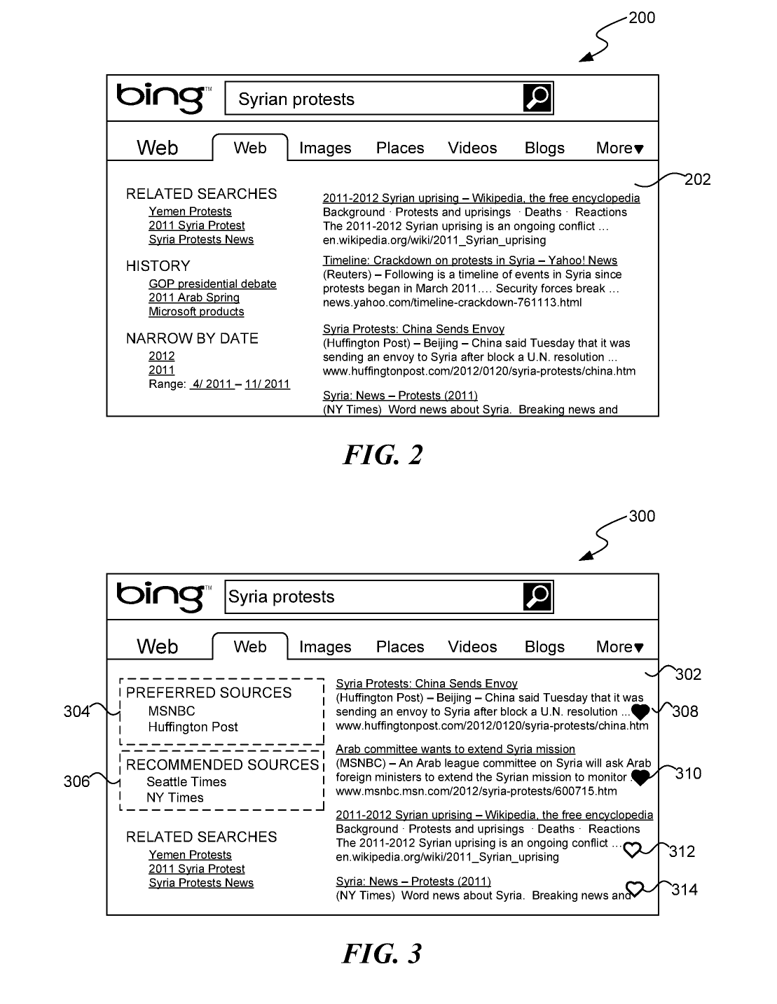

Turning now to FIG. 2, this figure illustrates an exemplary browser window 200, as executed on a user computer, such as any one of user computers 102-106 of FIG. 1. The browser window 200 shows typical search results 202 responsive to a search query, in this case “Syrian protests.” While typical search results may be customized according to a user's preferences in which some items are explicitly identified (friends, specific articles, activities, etc.) and others are implied by the system, current search engines fail to enable a user to explicitly prefer a source of content and subsequently arrange search results from a query with regard to the preferred sources. Accordingly, these search results 202 have not been updated according to explicit user personalization with regard to preferred sources.

By way of example to illustrate personalization based on preferred sources, assume that MSNBC and Huffington Post are the user's preferred sources. For the search, Syrian protests, since the search engine 110 has not personalized the search results 202 according to the user's preference of these two preferred sources, the search results from these sources are not necessarily given the appropriate level of prominence. Indeed, the search results 202 do not include any references from MSNBC—a preferred source.

In contrast to FIG. 2, FIG. 3 illustrates an exemplary browser window 300 as may be executed on the same user computer as in FIG. 2, but showing search results responsive to the same search query as above that are further updated according to the user's explicit preferred sources (as discussed in the example of the prior paragraph.) As can be seen, the content corresponding to the user's preferred sources (Huffington Post and MSNBC) are placed in prominent positions in the search results 302. Moreover, in this illustrative browser window 300, icons 308 and 310 are used to indicate the search results that reference content from the user's preferred sources.

It should be appreciated that in identifying and repositioning search results (i.e., content) from preferred sources, the search engine 110 is working with search results that have already been identified as being relevant to some degree or another. Of course, while the illustrative browser window 300 has the search results from the preferred sources in the most prominent positions (i.e., the first and second results), the search engine 110 may not be constrained to place content from preferred sources in specific positions. As those skilled in the art will appreciate, individual search results in the set of search results responsive to a query are scored with regard to the query. Typically, those search results with the highest score are placed in positions of greater prominence. Customizing the search results according to user personalization means that certain search results are weighted differently. According to one embodiment of the disclosed subject matter, the search engine 110 adds explicitly preferred sources as a weighting criterion or value to the scores. A search engine service would be free to choose the amount of weighting to lend to explicitly preferred sources.

With regard to customizing the search results according to the user and also in identifying search results that are from preferred sources, while some search engines allow a user to rearrange the order of the search results, the rearranging is limited to the current page of search results (i.e., the 10 search results displayed per each page—also referred to as the “10 blue links”.) However, knowing that a user prefers a particular source for content, search results that might otherwise fall outside of the first page of results may actually be highly relevant. Thus, in accordance with the disclosure subject matter, the search engine 110 searches through the first n search results for content from a preferred source, where n is a number greater than the results on a page of search results. By way of example and not to be meant as limiting, n may be the first 50 results or the first 100 results.

In regard to FIG. 3, in addition to the icons that indicate search results to content from preferred sources (such as icons 308 and 310), the illustrative browser window 300 includes additional user interface tools. Since only a few search results of a search page can be displayed “above the fold” (meaning those search results in a search results page that are visible when initially displayed in a window, such as browser window 300), a list 304 is shown that indicates the presence of content from preferred sources in the search results page. For example, list 304 of the browser window 300 identifies the user's preferred sources that are found in the entire search results page. Similarly, list 306 provides suggestions to the user with regard to other sources that the user may wish to add as a preferred source. Recommended sources are not necessarily constrained to those sources of search results that are included on the search results page.

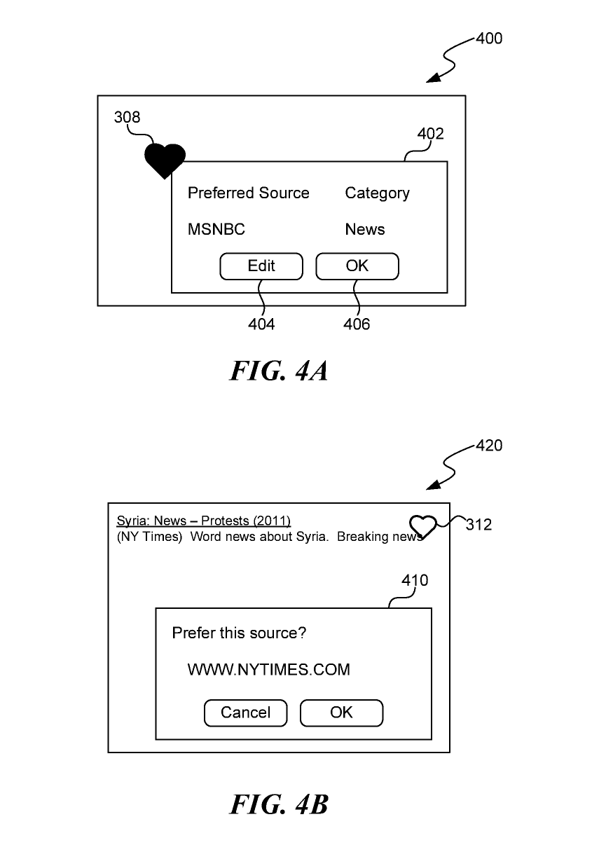

In addition to the preferred sources list 304 and recommended sources list 306, the generated search results page may also include icons 312 and 314 are actionable icons in conjunction with search results that do not correspond to preferred sources. In other words, actionable icons provide an easy manner in which a user may include the source of the search result as a preferred source. In fact, both icons 308-310 and icons 312-314 may be actionable icons thereby giving the user the ability to control the user's own preferred sources. For example, FIG. 4A illustrates an exemplary view 400 with regard to a search result identified as being from a preferred source. Thus, by way of example, upon selecting icon 308, an interactive window 402 may be displayed showing both the preferred source, in this example MSNBC, a category in which this source is to be preferred (“News”), and interactive controls 404 and 406 by which a user may edit/change information regarding the particular preferred source. Similarly, FIG. 4B illustrates an exemplary view 420 with regard to a search result that is not from a preferred source. In this example, upon selecting icon 312, an interactive window 410 is presented with controls that enable the user to add the source of the particular search result as one of the user's preferred sources.

As mentioned above in regard to FIG. 4A, it is further anticipated that a suitably configured search engine 110 will enable a user to not only explicitly identify and manage preferred sources of content, but also identify a category (or domain) in which a preferred source is preferred. For example, in FIG. 4A the interactive window 402 shows that the preferred source, MSNBC, is preferred when the category of content is “News.” Hence, assuming that a user prefers MSNBC just for news (as shown in interactive window 402) if the user submits a search query regarding dining, MSNBC would not be a preferred source and content from MSNBC would not be promoted as described above. According to various embodiments of the disclosed subject matter, a search engine 110 could enable a user to prefer a source and optionally associate one or more categories with that source. It is further anticipated that a user may associate subcategories of varying levels, with a preferred source. Moreover, a preferred source may be associated with more than one category/subcategory.

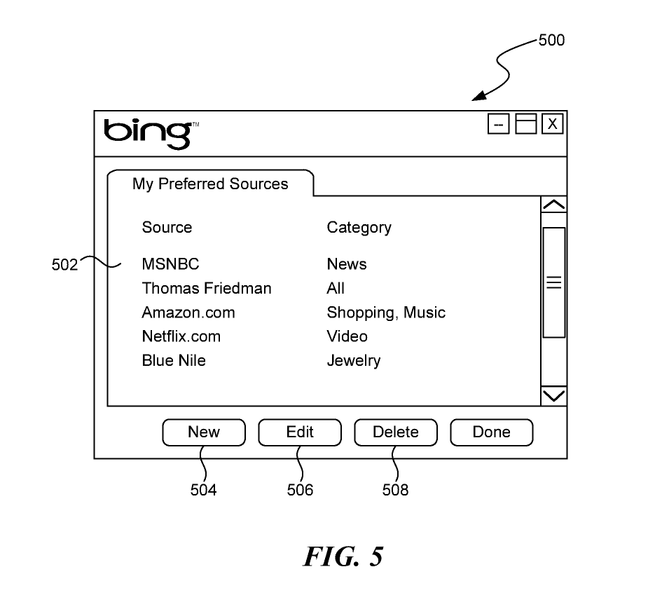

Part of enabling users to explicitly prefer sources is that a user should be able to control his/her own preferences. To that end, FIG. 5 illustrates an exemplary browser window 500 for displaying and editing a user's preferred sources. As can be seen in the browser window 500, a list of preferred sources 502 associated with the user is presented along with a corresponding category for the preferred sources. Controls 506-508 are provided to enable the user to edit or delete aspects of preferred sources, as well as a control 504 to add a new preferred source.

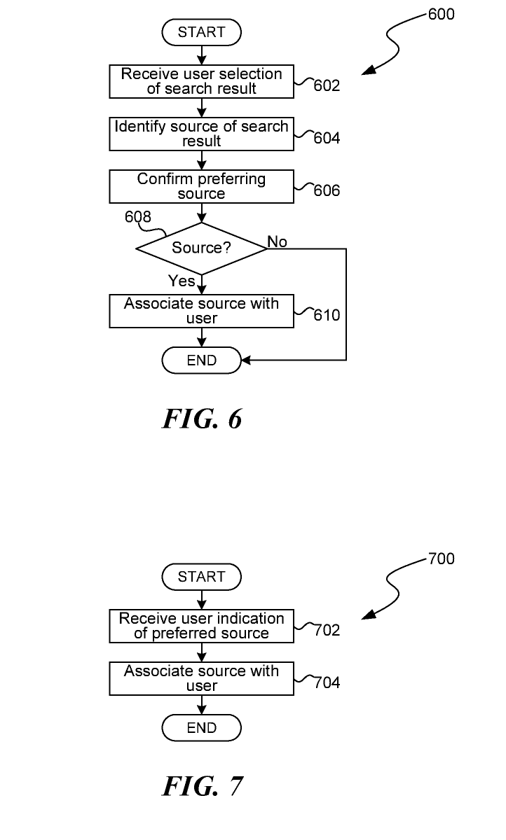

Turning now to FIG. 6, this figure illustrates a flow diagram of a computer-implemented routine 600, as executed by a search engine 110, for adding the source of a search result to the user's list of preferred sources. Beginning at block 602, the search engine 110 receives a user's selection of a search result. While it is anticipated that there are numerous manners in which a user may identify a content source for inclusion in the user's list of preferred sources, the examples of FIG. 3 and FIG. 4B discussed above illustrate one such manner, i.e., selecting icon 312 a user may prefer the source of the search result. Accordingly, at block 604, the search engine 110 identifies the source of the selected search result. At block 606, the search engine 110 presents a message to the user confirming the user's selection of the source of the search result as a preferred source. At decision block 608, the search engine 110 confirms whether or not the user intends to prefer the identified source. If the user does not confirm the use of the source of the search result as a preferred source, the routine 600 terminates. However, if the user confirms the use of the source as a preferred source, at block 610, the search engine 110 associates the identified source with the user as a preferred source. Thereafter, the routine 600 terminates.

As mentioned earlier, a user is not constrained to identifying preferred sources through icons associated with search results. To that end, FIG. 7 illustrates a flow diagram of a computer-implemented routine 700, as executed by a search engine 110, for receiving explicitly identified preferred sources. Beginning at block 702, the search engine receives a user indication of a preferred source. At block 704, the search engine associates the preferred source with the user. Thereafter, the routine 700 terminates.

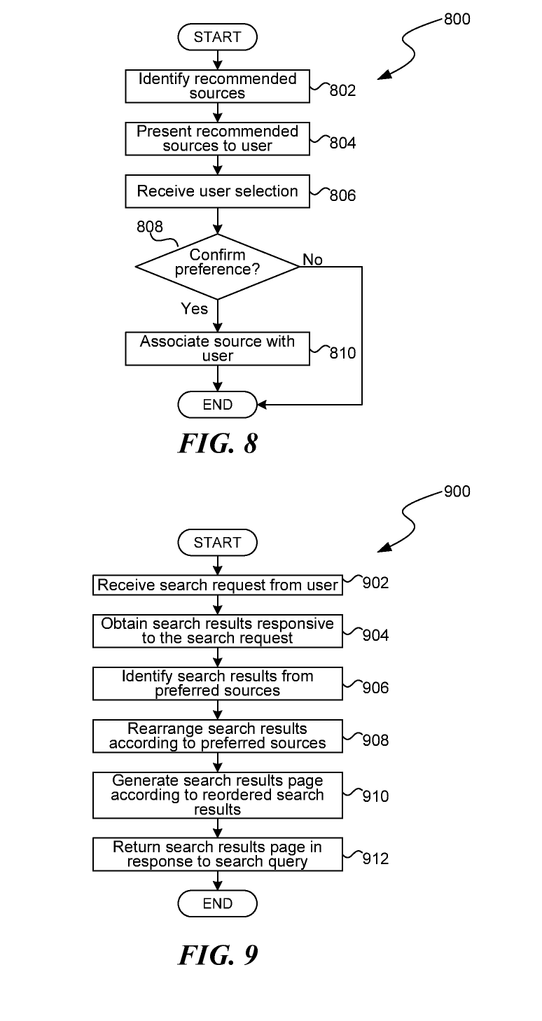

FIG. 8 illustrates a flow diagram of a computer-implemented routine 800, as implemented by a search engine 110, for presenting and processing recommended sources to a user as potential preferred sources. Beginning at block 802, the search engine identifies a number of recommended sources that the user may wish to adopt as preferred sources. At block 804, the identified recommended sources are presented to the user. At block 806, the search engine receives a user selection regarding a recommended preferred source. At decision block 808, the search engine 110 confirms with the user that the user wishes to use the selected source as a preferred source. If the user declines to confirm, the routine 800 terminates. Alternatively, if the user confirms the use of the recommended source as a preferred source, at block 810, the search engine 110 associates the source as a preferred source with the user. Thereafter, routine 800 terminates.

FIG. 9 illustrates a flow diagram of a computer-implemented routine 900 for processing a set of search results responsive to a user's query in accordance with the user's preferred sources. Beginning at block 902, the search engine 110 receives a search request from the user via a user computer, such as user computer 102. At block 904, the search engine obtains a set of search results responsive to the user's search request. At block 906, the search engine 110 identifies those search results where the source of the search result corresponds to a preferred source for the user. At block 908, the search engine rearranges (i.e., customizes and/or personalizes) the set of search results for the user such that the search results from preferred sources are placed in more prominent positions within the set of search results. At block 910, a search results page is generated according to the rearranged set of search results. At block 912, the generated the search results page is returned in response to the search query. Those skilled in the art will appreciate that in generating a search results page, a search engine 110 will often include one or more advertisements in the search results page. According to various embodiments, advertisements may be selected for inclusion in the search results page. By way of a non-limiting example, an advertisement may be selected when the advertisement corresponds to the preferred source of a search result in the search results page. Thereafter, the routine 900 terminates.

Regarding FIGS. 6-9, it should be appreciated that while routines 600-900 are expressed with discrete steps, these steps should be viewed as being logical in nature and may or may not correspond to any actual, discrete steps. Those skilled in the art will appreciate that logical steps may be combined together or be comprised of multiple steps. Further, while novel aspects of the disclosed subject matter are expressed in routines or methods, this functionality may also be embodied in computer-readable media. As those skilled in the art will appreciate, computer-readable media can host computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

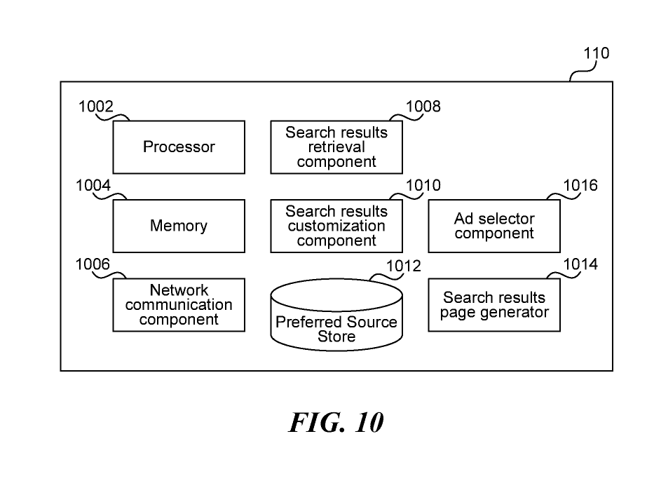

Turning now to FIG. 10, this figure shows a block diagram illustrating various components of a search engine 110 suitable to personalize search results according to a user's preferred sources. The search engine 110 includes a processor 1002 and a memory 1004. As those skilled in the art will appreciate, the processor 1002 executes instructions retrieved from memory 1004 in carrying out various aspects of the hosted service, including personalizing search results according to a user's preferred sources.

The search engine 110 also includes a network communications component 1006 through which the search engine sends and receives communications over the network 108. For example, it is through the network communication component 1006 that the search engine 110 receives search queries from user computers, such as user computers 102-106, and returns results responsive to the search queries. The search engine 110 further includes a search results retrieval component 1008, a search results personalization component 1010, a preferred source store 1012, a search results generator component 1014 and an ad selector component 1016.

The search results retrieval component 1008 retrieve/obtains a set of search results responsive to a user's search query. The search results personalization component 1010 rearranges the search results that were obtained from the search results retrieval component 1008 according to the user's preferred sources. Search results referencing content from preferred sources are place in more prominent positions in the rearranged set of search results. Frequently, these prominent positions include being placed on the first page of generated search results pages for the set of search results. Other prominent positions include earlier placement on a given search results page (such as one of the first three search results or above the fold). Of course, other personalization operations may take place within the search results personalization component 1010. These other customizations may include arranging the search results according to preferences implicitly derived by examining the user's browsing history, purchase history, and the like.

The preferred source store 1012 stores a list of preferred sources for each of a plurality of users. Typically, when a search engine 110 receives a search query from a user, the search engine will use that user's list of preferred sources as stored in the preferred source store 1012 when personalizing the search results for the user. However, in an alternative embodiment of the disclosed subject matter, the search engine 110 could enable a first user to use the preferred sources of a second user in personalizing the search results responsive to a search query from the first user. In another embodiment, the search engine 110 could enable a first user to use any number of combinations of preferred sources lists.

The search results page generator component 1014 is configured to generate one or more search results pages based on a set of search results. The search results page generator component 1014 is also configured to place a preferred source indicator proximate to those search results in a generated search results page that are from preferred sources. For those search results that are not from, or correspond to, preferred sources (i.e., the search results do not reference content from preferred sources), the search results page generator component 1014 is configured to place an actionable icon adjacent to a search result such that the user can readily preferred the source of the search result, i.e., add the source of a particular search result to the user's preferred source list in the preferred source store 1012.

The search results page generator component 1014 works with the ad selector component 1016 when generating a search results page. More specifically, the search results page generator component 1014 obtains suitable advertisements to be included in any given search results page. Moreover, according to novel aspects of the disclosed subject matter, the ad selector component 1016 selects suitable advertisements for inclusion in a search results page such that an advertisement corresponding to a preferred source is included in a search results page when a search result corresponding to that preferred source is included in the same search results page.

While the previous embodiments for personalizing search results according to a user's preferred sources have been largely described in terms of personalizing the results after a set of search results has been obtained, the disclosed subject matter is not so limited. In at least one alternative embodiment to those already described, information regarding a user's preferred sources is used as a signal to the service/component that retrieves or obtains a set of search results (such as the search results retrieval component 1008), such that results referencing content from preferred sources are already place in prominent positions among the set of search results. In such an embodiment, and if identifying the results referencing content from preferred sources is important, then the retrieved set of search results will include indications as to those that are from preferred sources. In short, search results referencing content from preferred sources can be placed in prominent positions after a set of search results has been retrieved, or the user's preferred sources can be supplied as a signal to the retrieval component such that search results referencing content from preferred sources are already placed in prominent positions when the search results set is retrieved.

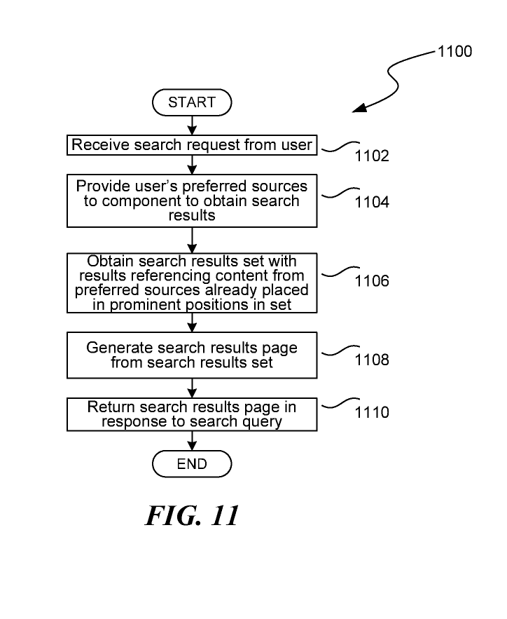

FIG. 11 shows a flow diagram of an exemplary routine 1100 illustrating these alternative embodiments of responding to a search query with a set of search results having those results referencing content from preferred sources located in more prominent positions in the set of search results. Beginning at block 1102, the search engine 110 receives a search request from the user via a user computer, such as user computer 102. At block 1104, the user's preferred sources are provided as a signal (i.e., information) to the service/component that retrieves a corresponding set of search results. At block 1106, the search engine 110 obtains a set of search results responsive to the user's search request. This set of search results is already arranged such that the results that reference content from a preferred source have been placed in positions of prominence in the set of search results. At block 1108, a search results page is generated according to the obtained set of search results. At block 1110, the generated the search results page is returned in response to the search query. Of course, just as with routine 900 discussed above, those skilled in the art will appreciate that in generating a search results page, a search engine 110 will often also include one or more advertisements in the search results page. Thereafter, the routine 900 terminates.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for personalizing search results responsive to a search query, the method comprising:
receiving an explicit indication of a preferred source for a first user;
receiving a search query from the first user;
obtaining an initial set of search results responsive to the search query;
identifying one or more search results in the initial set of search results that correspond to the preferred source;
rearranging the initial set of search results with the one or more search results placed in more prominent positions in the set search of search results;
generating a search results page according to the rearranged set of search results;
returning the search results page in response to the search query.

2. The computer-implemented method of claim 1, wherein rearranging the initial set of search results with the one or more search results in more prominent positions in the set of search results comprises rearranging the initial set of search results such that the one or more search results will be placed in the first search results page upon generating at least one search results page responsive to the search query.

3. The computer-implemented method of claim 1, wherein the initial set of search results is an ordered set of search results according to a score associated with each search result in the set, and wherein rearranging the initial set of search results with the one or more search results in more prominent positions in the set of search results comprises rescoring the one or more search results as a function of their initial score and a weighting value associated with preferred sources and placing the rescored search results in the ordered set of search results according to their new score.

4. The computer-implemented method of claim 1, wherein the one or more search results are identified from a subset of the initial set of search results, and wherein the subset of the initial set of search results comprises a number of search results larger than the number of search results that can be included in the first page of a generated search results page.

5. The computer-implemented method of claim 1, wherein the search query corresponds to a category of content and wherein identifying one or more search results from the initial set of search results comprises identifying one or more search results from the initial set of search results that correspond to the first user's preferred source which are preferred for the category of content corresponding to the search query.

6. The computer-implemented method of claim 1, wherein generating a search results page according to the rearranged set of search results comprises placing a preferred indicator next to each of the one or more search results to indicate that each of the one or more search results references content from a preferred source.

7. The computer-implemented method of claim 6, wherein generating a search results page according to the rearranged set of search results further comprises placing a non-preferred indicator next to search results in the search results page that do not reference content from a preferred source, the second indicator being an user-actionable indicator enabling the first user to add the source of the corresponding search result as a preferred source for the first user.

8. The computer-implemented method of claim 1, wherein generating a search results page according to the rearranged set of search results comprises including a list of preferred sources on the search results page, the list of preferred sources including all preferred sources for those search results in the search results page.

9. A computer system for personalizing search results according to a user's preferred sources, the system comprising:
a processor and a memory, wherein the processor executes instructions stored in the memory as part of or in conjunction with additional components to customize search results according to a user's preferred sources, the additional components including:
a network communication component;
a search results retrieval component;
a search results page generator component; and
preferred source store that maintains a list of preferred sources for each of a plurality of users;
wherein, in operation, the system:
receives information regarding a search query from a first user via the network communication component;
obtains a set of search results responsive to the search query via the search results retrieval component, wherein the set of search results includes at least one search result referencing content from a preferred source of the first user, and wherein the at least one search result is placed in a prominent position in the set of search results;
generates a search results page according to the set of search results, via the search results page generation component, including identifying the at least one search result with an indicator signifying that the at least one search result references content from a preferred source; and
returns the generated search results page in response to the search query via the network communication component.

10. The system of claim 9 further comprising a preferred source store that maintains a list of preferred sources for each of a plurality of users, including the first user, and wherein the system provides the user's list of preferred sources as a signal to the search results retrieval component in obtaining the set of search results responsive to the search query via the search results retrieval component.

11. The system of claim 9 further comprising a search results personalization component, and wherein the system:
obtains an initial set of search results responsive to the search query via the search results retrieval component;
identifies the at least one search result from the initial set of search results and rearranges the initial set of search results, via the search results personalization component, such that the at least one search result is placed in a prominent position in the rearranged set of search results; and
generates a search results page according to the rearranged set of search results, via the search results page generation component.

12. The system of claim 11, wherein the search query corresponds to a category of content and wherein the system identifies the at least one search result from the initial set of search results by identifying the at least one search result from the initial set of search results that corresponds to a preferred source and that is preferred for the category of content corresponding to the search query.

13. The system of claim 11, wherein the system further generates the search results page according to the rearranged set of search results by placing a second indicator next to search results in the search results page that do not reference content from a preferred source of the first user, the second indicator being a user-actionable indicator enabling the first user to add the source of the corresponding search result as a preferred source.

14. The system of claim 11, where the system further generates the search results page according to the rearranged set of search results by obtaining an advertisement associated with a preferred source corresponding to a search result in the search results page, and including the advertisement on the search results page.

15. The system of claim 11, where the system further generates the search results page according to the rearranged set of search results by including a list of preferred sources in the search results page, the list of preferred sources including preferred sources of the first user for those search results in the search results page.

16. A computer-readable medium bearing computer-executable instructions which, when executed on a computing system comprising at least a processor and a memory, carry out the following:
receiving a search query from a user;
obtaining an initial set of search results responsive to the search query, the initial set of search results comprising an ordered set of search results according to a score for each search result;
identifying at least one search result that references content from a preferred source of the user from a subset of the initial set of search results, the subset comprising a number of search results greater than the number of search results that are included in a generated search results page;
rearranging the initial set of search results with the at least one search result placed in a more prominent position in a rearranged set of search results such that the at least one search result will be included in the first generated search results page for the rearranged set of search results;
generating a search results page from the rearranged set of search results, including placing a preferred source indicator proximate to the at least one search result indicating that the at least one search result references content from a preferred source;
returning the generated search results page in response to the search query.

17. The computer-readable medium of claim 16, wherein the search query corresponds to a category of content and wherein identifying at least one search result that references content from a preferred source of the user from a subset of the initial set of search results further comprises identifying the at least one search result from the initial set of search results that references content from the preferred source and that is preferred for the category of content corresponding to the search query.

18. The computer-readable medium of claim 16, wherein generating a search results page from the rearranged set of search results further comprises placing a non-preferred source indicator next to search results in the generated search results page that do not reference content from a preferred source of the user, the non-preferred source indicator being an user-actionable indicator enabling the user to add the source of the corresponding search result as a preferred source for the user.

19. The computer-readable medium of claim 18, wherein generating the search results page from the rearranged set of search results further comprises obtaining an advertisement associated with a preferred source of at least one search result and including the advertisement on the search results page.

20. The computer-readable medium of claim 18, wherein generating the search results page from the rearranged set of search results further comprises including a list of preferred sources in the search results page, the list of preferred sources including the sources of the search results in the search results page that are preferred by the user.
